(19) United States
(12) Patent Application Publication
(10) Pub. No.: US 2005/0091322 A1
(43) Pub. Date: Apr. 28, 2005

(54) Method, system and program product for communicating over a network

(75) Inventors: Matt R. Hogstrom, Apex, NC (US); Anthony R. Tuel, Cary, NC (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/694,141

(22) Filed: Oct. 27, 2003

(51) Int. Cl. G06F 15/16

(52) U.S. Cl. 709/206

(57) ABSTRACT

An improved solution for communicating over a network. In particular, a set of rules is defined on a server and provided to a client. The set of rules on the client can be periodically synchronized with the set of rules on the server. The client uses the set of rules to classify messages before they are sent to the server. The server can separately monitor for messages having a particular message classification and can process the messages accordingly. As a result, messages are classified on a client while maintaining the flexibility to change message classifications on the server.

### BACKGROUND OF THE INVENTION

1. Technical Field

The invention relates generally to communicating over a network, and more specifically, to a method, system and program product that classify messages on a client before sending the messages to a server for processing.

2. Background Art

A server is often shared by numerous users that are performing various operations. Frequently, it is desirable to assign different priorities and/or groupings for processing messages that are communicated to the server in conjunction with these operations. For example, a first group of one or more users may be performing operations on a server that are expected to have a quick response time (e.g., obtaining stock quotes), while a second group of one or more users may be performing operations that do not require a quick response time and/or take up a large number of server resources. Ideally, the server will assign a different priority for the operations. For example, the operations that do not require a quick response time could be assigned a lower priority so that the performance of these operations does not interfere with the operations that require a quick response time. Additionally, when a lot of server resources are consumed by an operation, the number of these operations that are being processed could be limited so that the server does not deadlock.

Current solutions often require the server to accept unclassified messages, decode the messages, and classify the messages for processing. For example, in a typical implementation, a thread may accept connections from various clients, and store the corresponding messages in a queue. One or more additional threads may then be used to decode and classify the messages and place the classified messages in the corresponding processing queues. Subsequently, various threads for processing the messages can obtain the messages from their own processing queue, and process the messages.

Requiring the server to declassify messages has several drawbacks. For example, information for classifying the message may be contained within several protocol layers for transporting the message (e.g., HyperText Transport Protocol (HTTP), Internet Inter-Object Request Broker (ORB) Protocol (IIOP), etc.). As a result, nearly the entire message must be decoded to properly classify the message. However, some messages may not be classified resulting in reduced performance. For these messages, this decoding may be performed unnecessarily. Further, an additional thread is frequently implemented for decoding and classifying the messages. The extra thread competes with other threads for the server resources (e.g., CPU time slices, cache memory space, etc.) thereby decreasing the overall performance of the server. Still further, an additional queue for decoding and classifying messages adds additional response time for messages that wait in the queue for processing, and requires synchronization between the threads that are accepting connections and those performing the classification.

Other solutions require a client-side software developer to understand how a message is classified, and route messages appropriately. However, these solutions result in classifications that cannot be easily changed once the client software is deployed. These solutions may also result in a situation in which a server is underutilized due to static deployments that are unable to adjust to fully utilize the server. As a result, the amount of flexibility and control maintained on the server can be substantially reduced.

As a result, a need exists for an improved solution for classifying messages. In particular, a need exists for a method, system and program product for classifying messages on a client prior to communicating the messages to a server, in which the classification rules are provided to the client from the server.

### SUMMARY OF THE INVENTION

The invention provides a method, system and program product for communicating over a network. Specifically, under the present invention, a server generates a set (i.e., one or more) of rules for classifying messages. The set of rules is provided to clients for use when communicating with the server, and the client's set of rules can be periodically synchronized with the set of rules on the server. Before the client communicates a message to the server, the client can classify the message using the set of rules. Messages can be sent, for example, over different ports according to the message classification. In this case, the server can separately monitor multiple ports for messages, and process the messages accordingly. As a result, the invention provides an improved solution for classifying messages for processing on a server.

A first aspect of the invention provides a method of communicating over a network, the method comprising: obtaining a set of rules for classifying messages on a client; providing a message on the client to be sent to a server; classifying the message on the client based on the set of rules; and sending the message to the server based on the message classification.

A second aspect of the invention provides a method of communicating over a network, the method comprising: creating a set of rules for classifying messages; providing the set of rules to a client; and separately monitoring on a server for classified messages having one of a plurality of message classifications based on the set of rules.

A third aspect of the invention provides a system for communicating over a network, the system comprising: a rules system for managing a set of rules for classifying messages; an update system for providing the set of rules to a client; and a plurality of monitoring systems, wherein each monitoring system monitors for messages having a unique message classification.

A fourth aspect of the invention provides a program product stored on a recordable medium for communicating over a network, which when executed comprises: program code for managing a set of rules for classifying messages; program code for providing the set of rules to a client; and program code for separately monitoring a plurality of ports on a server for classified messages.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative system for communicating over a network according to one embodiment of the invention;

FIG. 2 shows an illustrative data flow between the systems according to another embodiment of the invention; and

FIG. 3 shows an illustrative message being sent to the server according to still another embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a method, system and program product for communicating over a network. Specifically, under the present invention, a server generates a set (i.e., one or more) of rules for classifying messages. The set of rules is provided to clients for use when communicating with the server, and the client's set of rules can be periodically synchronized with the set of rules on the server. Before the client communicates a message to the server, the client can classify the message using the set of rules. Messages can be sent, for example, over different ports according to the message classification. In this case, the server can separately monitor multiple ports for messages, and process the messages accordingly. As a result, the invention provides an improved solution for classifying messages for processing on a server.

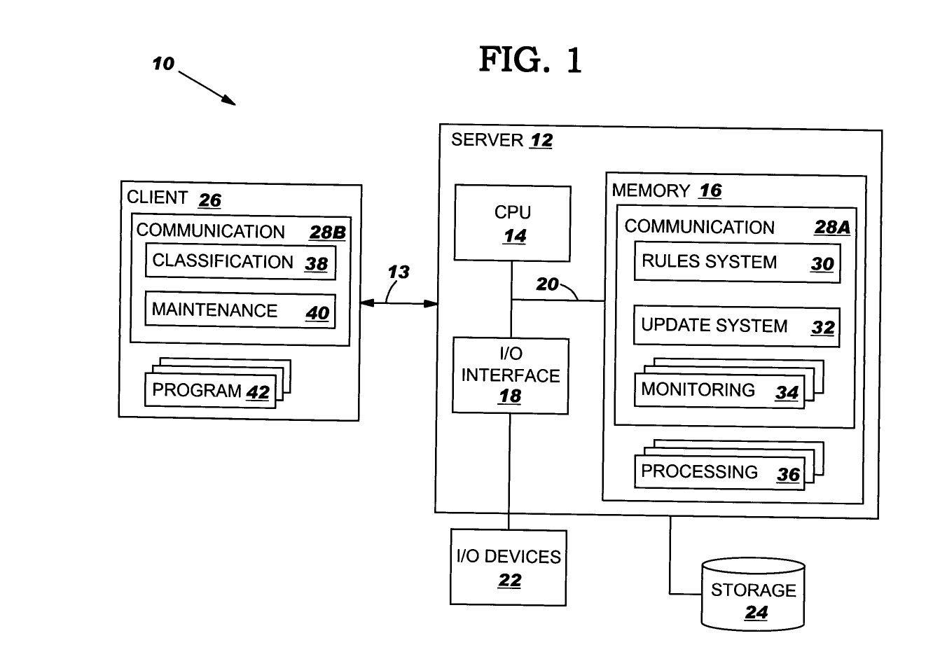

Turning to the drawings, FIG. 1 shows an illustrative system 10 for communicating over a network 13. In particular, server 12 and client 26 communicate over network 13 using communication systems 28A-B, respectively. To this extent, network 13 can comprise any type of communications link. For example, network 13 can comprise an addressable connection in a client-server (or server-server) environment that may utilize any combination of wireline and/or wireless transmission methods. In this instance, server 12 and client 26 may utilize conventional network connectivity, such as Token Ring, Ethernet, WiFi or other conventional communications standards. Further, network 13 can comprise any type of network, including the Internet, a wide area network (WAN), a local area network (LAN), a virtual private network (VPN), etc. Where client 26 communicates with server 12 via the Internet, connectivity could be provided by conventional TCP/IP sockets-based protocol, and client 26 could utilize an Internet service provider to establish connectivity to server 12.

As shown, server 12 generally includes central processing unit (CPU) 14, memory 16, input/output (I/O) interface 18, bus 20, external I/O devices/resources 22, and a storage unit 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Storage unit 24 may comprise any type of data storage for providing storage for information necessary to carry out the invention as described below. As such, storage unit 24 may include one or more storage devices, such as a magnetic disk drive or an optical disk drive. Moreover, similar to CPU 14, memory 16 and/or storage unit 24 may reside at a single physical location, comprising one or more types of data storage, or be distributed across a plurality of physical systems in various forms. Further, memory 16 and/or storage unit 24 can include data distributed across, for example, a LAN, WAN or a storage area network (SAN) (not shown).

I/O interface 18 may comprise any system for exchanging information to/from an external source. I/O devices 22 may comprise any known type of external device, including speakers, a CRT, LED screen, handheld device, keyboard, mouse, voice recognition system, speech output system, printer, monitor/display, facsimile, pager, etc. Bus 20 provides a communication link between each of the components in server 12 and likewise may comprise any known type of transmission link, including electrical, optical, wireless, etc. In addition, although not shown, additional components, such as cache memory, communication systems, system software, etc., may be incorporated into server 12.

Further, it is understood that server 12 comprises any type of computing device capable of communicating with one or more other computing devices (e.g., client 26). Similarly, client 26 can comprise any type of computing device, such a server, a desktop computer, a laptop, a handheld device, a mobile phone, a pager, a personal data assistant, etc. To this extent, client 26 typically includes the same elements as shown in server 12 (e.g., CPU, memory, I/O interface, etc.). These have not been separately shown and discussed for brevity. It is understood, however, that if client 26 is a handheld device or the like, a display could be contained within client 26, and not as an external I/O device 22 as shown for server 12.

Shown stored in memory 16 and on client 26 are communication systems 28A-B for communicating between server 12 and client 26 over network 13. Further, a plurality of processing systems 36 are shown in memory 16 of server 12 and a plurality of programs 42 are shown on client 26. In general, a program 42 generates a message that is to be communicated to server 12 for processing by a processing system 36. Once processing of the message is complete, processing system 36 may send a response message to program 42.

In order to implement the communications between the server and client, communication system 28A on server 12 is shown including a rules system 30, an update system 32, and a set (one or more) of monitoring systems 34, and communication system 28B is shown including a classification system 38 and a maintenance system 40. In general, each monitoring system 34 monitors for messages of a unique message classification, and forwards any messages received to a corresponding processing system 36. Rules system 30 can be used to manage a set of rules for communicating classified messages from client 26 to server 12, and update system 32 can provide the set of rules to maintenance system 40 for use on client 26. When a message is to be sent from client 26 to server 12, classification system 38 can reference the set of rules to determine how to classify the message before sending it to server 12.

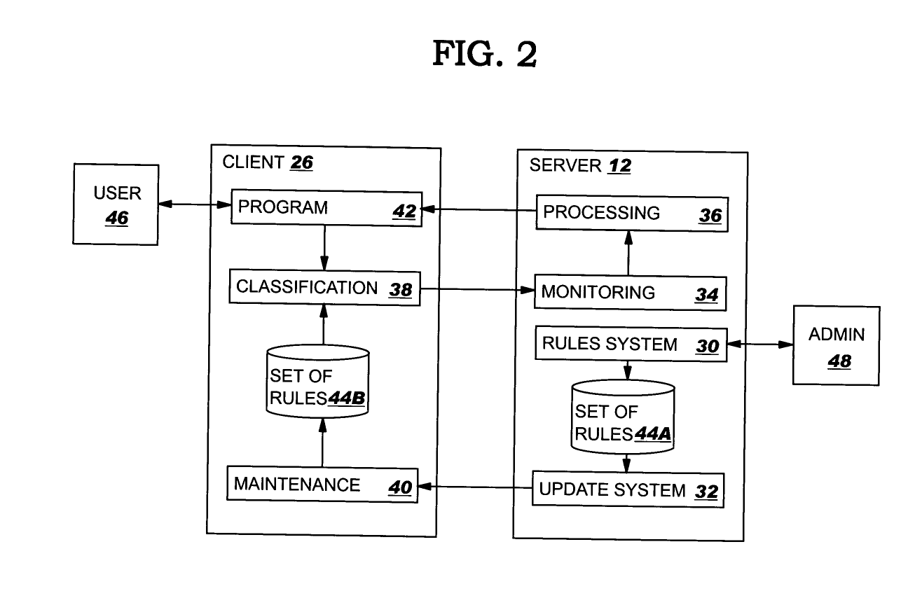

Turning to FIG. 2, an illustrative data flow between the various systems is shown. As shown, sets of rules 44A-B are stored on server 12 and client 26, respectively (e.g., on a storage unit 24 (FIG. 1)). Each set of rules 44A-B includes one or more rules for classifying messages, and each rule specifies how to classify one or more messages based on one or more attributes of the message. Consequently, set of rules 44B is used by client 26 to classify messages that are sent to server 12. Messages can be classified using any attribute of the message, including for example, one or more attributes of program 42 that is sending the message, the content of the message, the client 26 from which the message is being sent, the processing system 36 processing the message, or the like. For example, a rule can comprise a message type and the classification information that corresponds with the message type. In this case, each message having a message type that matches the message type for the rule will be classified based on the corresponding classification information.

An administrator 48 can manage set of rules 44A using rules system 30. In particular, rules system 30 can provide an interface that allows administrator 48 to create, delete, modify, view, etc. one or more rules in set of rules 44A. Set of rules 44B on client 26 comprises a copy of set of rules 44A that was obtained from server 12 at a particular time. For example, when client 26 has not yet acquired a set of rules 44B from server 12, maintenance system 40 can obtain a copy of set of rules 44A from update system 32 and store it as set of rules 44B.

Additionally, set of rules 44B can be periodically synchronized with set of rules 44A. For example, maintenance system 40 can periodically request an updated set of rules 44B from server 12. In one embodiment, set of rules 44B can include a date and/or time after which an updated set of rules 44B should be obtained. After this time, maintenance system 40 can request an updated set of rules 44B from update system 32. Alternatively, maintenance system 40 can request an updated set of rules 44B after a set time interval, at the same time every day, etc. In either case, client 26 can periodically synchronize its clock with server 12 to ensure that set of rules 44B is updated appropriately. In yet another alternative, update system 32 can broadcast one or more updates to set of rules 44A to client 26 for use as set of rules 44B periodically, after administrator 48 modifies set of rules 44A, or when administrator 48 requests that an updated set of rules 44A should be sent. In any event, update system 32 can provide the current set of rules 44A to maintenance system 40. Alternatively, update system 32 can provide a set of modifications made to set of rules 44A since set of rules 44B was previously synchronized, and/or a new date and/or time after which an updated set of rules is to be obtained (e.g., when no modifications were made to set of rules 44A). To this extent, set of rules 44B can further include a version or the like that identifies the particular set of rules 44B that is being updated with the current set of rules 44A, and maintenance system 40 can communicate the version to update system 32. Alternatively, maintenance system 40 can provide the date/time that set of rules 44B was previously obtained. In either case, update system 32 can determine the necessary modifications and provide them to maintenance system 40.

While a user 46 operates program 42, program 42 may generate a message to be sent to server 12. In this case, program 42 would provide the message to communication system 28B (FIG. 1). Before being communicated to server 12, classification system 38 can classify the message based on set of rules 44B. In particular, classification system 38 can determine one or more attributes of the message, and determine if a rule in set of rules 44B matches the one or more attributes. If a rule is present, classification system 38 can classify the message according to the corresponding classification information. If no rule is present, then classification system 38 can leave the message as unclassified. For example, classification system 38 can analyze the message to determine a message type, and then determine if a rule that corresponds to the determined message type is present in set of rules 44B. When a rule is found, the message can be classified according to the classification information in the rule, otherwise the message can remain unclassified. In either case, the message is communicated to server 12.

As noted previously, set of rules 44B can include a date and/or time after which an updated set of rules should be obtained. Classification system 38 can also access the date and/or time to determine whether set of rules 44B can continue to be used for classifying messages. For example, if set of rules 44B contains a date/time that has passed, classification system 38 can stop using set of rules 44B, rather than risk that one or more rules are no longer in use on server 12. Similarly, while set of rules 44B is being updated by maintenance system 40, classification system 38 can be prevented from accessing set of rules 44B. In either case, classification system 38 can send any message as unclassified to server 12.

Messages sent by client 26 are received by one of monitoring systems 34. Each monitoring system 34 can monitor for and receive messages having a unique message classification. When a classified message is received by a monitoring system 34, the monitoring system 34 can provide the message to a corresponding processing system 36 for processing the message. Further, a server 12 can include a monitoring system 34 for receiving unclassified messages, which can also provide messages to a processing system 36 for processing unclassified messages. While a particular processing system 36 might only process messages from a single monitoring system 34, it is understood that any relationship between monitoring systems 34 and processing systems 36 is possible.

Monitoring systems 34 and/or processing systems 36 can also be configured based on set of rules 44A. For example, when administrator 48 creates a rule that includes a new message classification, rules system 30 can start an additional monitoring system 34 to monitor for messages having the new message classification, and an additional processing system 36 for processing the messages. To this extent, similar to maintenance system 40, rules system 30 can periodically synchronize the configuration of monitoring systems 34 and/or processing systems 36 with set of rules 44A. For example, the configuration of monitoring systems 34 can be synchronized at the same time that set of rules 44B indicates that it should be updated. In this manner, it can be assured that the configuration of monitoring systems 34 on server 12 matches the set of rules 44B that is being used on client 26.

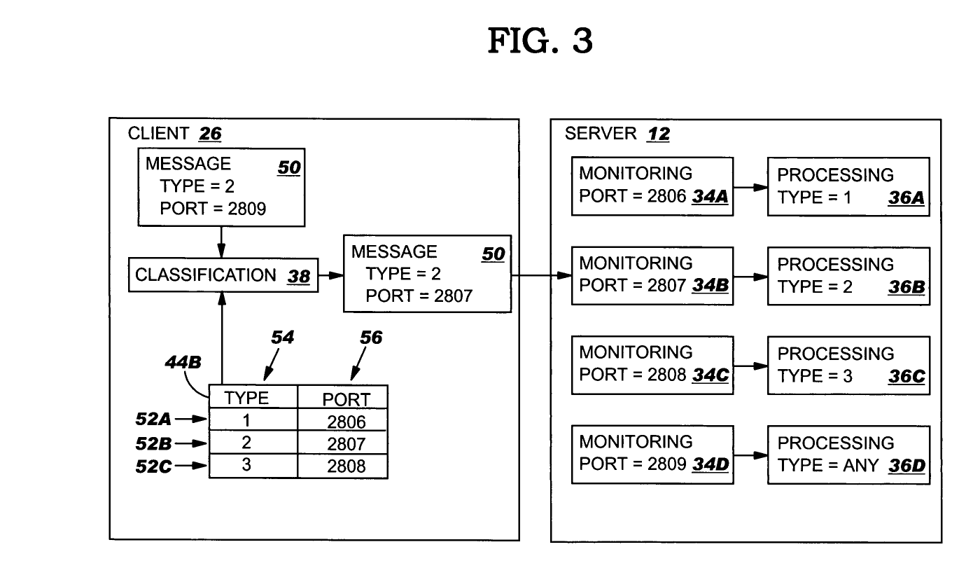

FIG. 3 shows an illustrative message 50 being sent to server 12 after being classified by classification system 38. In this case, set of rules 44B includes a plurality of rules 52A-C, in which each rule 52A-C includes a message type 54 for the attribute of the message and a corresponding port number 56 for the classification information. Message 50 can be received by classification system 38 specifying that it should be sent over the default port. Upon receiving message 50, classification system 38 can determine its message type. Classification system 38 can then determine if the message type 54 for a rule 52A-C matches the message type of message 50. When a match is found, classification system 38 can change the port for message 50 to the port number 56 in the matching rule 52A-C. For example, message 50 is shown having a message type equal to two and specifying a default port of 2809. The message type matches the message type 54 for rule 52B in set of rules 44B. Consequently, the port for message 50 is set to the port number 56 for rule 52B, e.g., port 2807.

Subsequently, message 50 is sent to server 12. If client 26 does not have a connection with server 12 for the port number (e.g., port 2807), communication systems 28A-B (FIG. 1) can first open a connection for the port. Once the connection is established, message 50 can be sent to server 12. As shown, server 12 can include a plurality of monitoring systems 34A-D, in which each monitoring system 34A-D separately monitors the ports for messages 50 having a unique message classification, e.g., sent over a unique port number. Further, each monitoring system 34A-D provides messages 50 received over the port number to a unique processing system 36A-D for processing the particular message classification, e.g., message type. In this manner, messages 50 of a particular message classification are efficiently forwarded to the processing system 36A-D that processes messages of the particular message classification. For example, message 50 is shown sent over port 2807, which is being monitored by monitoring system 34B. When message 50 is received by monitoring system 34B, it is provided to processing system 36B, which processes messages having a message type of two. Once processing is complete, processing system 36B can send a response message back to client 26 using the same port, e.g., port 2807.

Server 12 is also shown including a monitoring system 34D, which monitors the default port (e.g., port 2809). Monitoring system 34D forwards messages 50 received on the default port to a processing system 36D that can process messages 50 in any message classification (e.g., any type). This allows clients 26 that do not have a current set of rules 44B and/or a classification system 38 (e.g., previous versions of communication system 28B (FIG. 1)) to continue to successfully communicate with server 12 without using the message classification capability. Further, client 26 may bypass classification system 38 for some messages 50. For example, when a message 50 is part of a short lived connection (e.g., only a single message), the message 50 may be more efficiently sent over the default port, for which client 26 may already have an open connection with server 12. By bypassing classification system 38, the overhead of opening, maintaining, and closing a connection on a separate port for only a limited number of messages 50 would be avoided. While a plurality of monitoring systems 34A-D are shown and discussed, it is understood that the separate systems could be interpreted as a single monitoring system 34 that monitors a plurality of ports using, for example, a unique thread for each port.

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer (e.g., a finite state machine), containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of communicating over a network, the method comprising:
obtaining a set of rules for classifying messages on a client;
providing a message on the client to be sent to a server;
classifying the message on the client based on the set of rules; and
sending the message to the server based on the message classification.

2. The method of claim 1, wherein the providing step comprises generating the message.

3. The method of claim 1, further comprising periodically requesting an updated set of rules from the server.

4. The method of claim 1, wherein the classifying step includes matching an attribute of the message with at least one of the set of rules.

5. The method of claim 1, further comprising adjusting a port for the message based on the classification prior to the sending step.

6. The method of claim 1, further comprising opening a connection with the server for the message.

7. The method of claim 1, further comprising receiving a response message from the server.

8. The method of claim 7, wherein the classified message and the response message are communicated over a first port, and wherein the first port is not a default port.

9. The method of claim 1, further comprising separately monitoring a plurality of ports on the server for messages.

10. A method of communicating over a network, the method comprising:
creating a set of rules for classifying messages;
providing the set of rules to a client; and
separately monitoring on a server for classified messages having one of a plurality of message classifications based on the set of rules.

11. The method of claim 10, further comprising receiving a classified message from the client through a unique port.

12. The method of claim 11, further comprising:
processing the classified message; and
sending a response message to the client.

13. The method of claim 10, further comprising opening a connection with the client.

14. The method of claim 10, further comprising:
receiving a request from the client for an updated set of rules; and
sending the updated set of rules to the client.

15. A system for communicating over a network, the system comprising:
a rules system for managing a set of rules for classifying messages;
an update system for providing the set of rules to a client; and
a plurality of monitoring systems, wherein each monitoring system monitors for messages having a unique message classification.

16. The system of claim 15, further comprising a plurality of processing systems, wherein each processing system processes messages having a unique message classification.

17. The system of claim 15, further comprising a classification system for classifying messages on a client.

18. The system of claim 15, further comprising a maintenance system for periodically requesting the set of rules from the server.

19. The system of claim 15, wherein each monitoring system monitors a unique port of the server.

20. A program product stored on a recordable medium for communicating over a network, which when executed comprises:
program code for managing a set of rules for classifying messages;
program code for providing the set of rules to a client; and
program code for separately monitoring a plurality of ports on a server for classified messages.

21. The program product of claim 20, further comprising program code for classifying messages on a client.

22. The program product of claim 20, further comprising program code for periodically requesting the set of rules from the server.
